(19) United States
(12) Patent Application Publication
(10) Pub. No.: US 2024/0397260 A1
(43) Pub. Date: Nov. 28, 2024

(54) ARRAY MICROPHONE APERTURE PREDISTORTION FOR IMPROVED DIRECTIVITY

(71) Applicant: Shure Acquisition Holdings, Inc., Niles, IL (US)

(72) Inventor: Brent Robert Shumard, Mount Prospect, IL (US)

(21) Appl. No.: 18/671,392

(22) Filed: May 22, 2024

Related U.S. Application Data
(60) Provisional application No. 63/504,562, filed on May 26, 2023.

(51) Int. Cl. H04R 3/00; H04R 1/40; H04R 3/04

(52) U.S. Cl. CPC H04R 3/005; H04R 1/406; H04R 3/04

(57) ABSTRACT

Array microphone systems and methods for enabling predistortion of the aperture of an array microphone at various steering vectors are provided. The predistortion of the aperture can regularize the apparent aperture of the array microphone to be closer to that of the base aperture of the array microphone, while minimizing the number of microphone elements used. Improved directivity and more optimal pickup and capture of sound in the environment may result through the use of these systems and methods, which can help to avoid undesired noise and/or to more efficiently cover audio sources.

### CROSS-REFERENCE

This application claims priority to U.S. Provisional Patent Application No. 63/504,562, filed on May 26, 2023, which is incorporated by reference herein.

### TECHNICAL FIELD

This application generally relates to systems and methods that utilize aperture predistortion to maintain the directivity of array microphones over various steering vectors. In particular, this application relates to systems and methods that perform aperture predistortion to regularize the apparent aperture of array microphones by applying mask conditioning to microphone elements or by using a microphone element selection algorithm.

### BACKGROUND

Conferencing environments, such as conference rooms, boardrooms, video conferencing applications, and the like, can involve the use of microphones for capturing sound from various audio sources active in such environments. Such audio sources may include humans speaking, for example. The captured sound may be disseminated to a local audience in the environment through amplified speakers (for sound reinforcement), and/or to others remote from the environment (such as via a telecast and/or a webcast). The types of microphones and their placement in a particular environment may depend on the locations of the audio sources, physical space requirements, aesthetics, room layout, and/or other considerations. For example, in some environments, the microphones may be placed on a table or lectern near the audio sources. In other environments, the microphones may be mounted overhead to capture the sound from the entire room, for example. Accordingly, microphones are available in a variety of sizes, form factors, mounting options, and wiring options to suit the needs of particular environments.

Traditional microphones typically have fixed polar patterns and few manually selectable settings. To capture sound in a conferencing environment, many traditional microphones can be used at once to capture the audio sources within the environment. However, traditional microphones tend to capture unwanted audio as well, such as room noise, echoes, and other undesirable audio elements. The capturing of these unwanted noises is exacerbated by the use of many microphones.

Array microphones having multiple microphone elements can provide benefits such as steerable coverage or pick up patterns (having one or more lobes), which allow the microphones to focus on the desired audio sources and reject unwanted sounds such as room noise. The ability to steer audio pick up patterns provides the benefit of being able to be less precise in microphone placement, and in this way, array microphones are more forgiving. Moreover, array microphones provide the ability to pick up multiple audio sources with one array microphone or unit, again due to the ability to steer the pickup patterns.

The aperture of an array microphone generally refers to the maximum region in the environment where the array microphone can sense sounds, and can be related to the size of the array microphone and its constituent microphone elements as well as based on the frequency of the sounds being sensed. For example, the base aperture of a one-dimensional array microphone may be the distance between the microphone elements at its ends, while the base aperture of a two-dimensional array microphone may be a shape based on the geometry of the microphone elements.

However, as an array microphone is steered, the region of the environment that can be sensed may change such that an apparent aperture of the array microphone differs from the base aperture. In particular, the apparent aperture is typically perturbed (e.g., smaller or shaped differently) at different steering vectors, as compared to the base aperture. The change in a base aperture of an array microphone to a different apparent aperture can therefore result in less optimal coverage in an environment, such as picking up undesired audio sources and/or not picking up all desired audio sources.

Accordingly, there is an opportunity for array microphones that address these concerns. More particularly, there is an opportunity for systems and methods that regularize the apparent aperture of an array microphone to be closer to that of the base aperture, resulting in improved directivity and more optimal coverage of environments across various steering vectors.

### SUMMARY

The invention is intended to solve the above-noted problems by providing array microphone systems and methods that are designed to, among other things: (1) enable predistortion of the aperture of an array microphone at various steering vectors to be closer to that of a base aperture while minimizing the number of microphone elements being used; (2) apply mask conditioning to the signals of microphone elements of an array microphone to perform the aperture predistortion; and (3) optimally select microphone elements of an array microphone to perform the aperture predistortion.

In an embodiment, a device may include an array microphone comprising a plurality of microphone elements, and one or more processors in communication with the plurality of microphone elements. The one or more processors may be configured to generate a respective mask for each of the plurality of microphone elements based on: a location of each of the plurality of microphone elements and a steering vector; receive a microphone signal from each of the plurality of microphone elements; apply the respective mask to the microphone signal of each of the plurality of microphone elements to generate a respective filtered microphone signal; and generate a beamformed signal based on the filtered microphone signals.

In another embodiment, a device may include an array microphone comprising a plurality of microphone elements, and one or more processors in communication with the plurality of microphone elements. The one or more processors may be configured to determine an aperture profile based on a steering vector and a frequency range being sensed by array microphone; select one or more bounding microphone elements of the plurality of microphone elements based on the aperture profile; select one or more interior microphone elements of the plurality of microphone elements based on the bounding microphone elements and the aperture profile; receive microphone signals of the one or more bounding microphone elements and the one or more interior microphone elements; and generate a beamformed signal based on the microphone signals of the one or more bounding microphone elements and the one or more interior microphone elements.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 are depictions of a one-dimensional array microphone during a broadside condition and a steered condition.

FIG. 2 are depictions of a two-dimensional array microphone during a broadside condition and a steered condition.

FIG. 3 is a block diagram of an array microphone with mask conditioning of the signals of the microphone elements of the array microphone to perform aperture predistortion, in accordance with some embodiments.

FIG. 4 is a flowchart illustrating operations for applying mask conditioning to the signals of the microphone elements of an array microphone using the array microphone of FIG. 3, in accordance with some embodiments.

FIGS. 5A-C are exemplary graphs showing the magnitudes of a mask applied to signals of the microphone elements as a function of frequency for particular microphone elements, steering vectors, and beam widths.

FIG. 6 is a block diagram of an array microphone with optimal selection of microphone elements of the array microphone to perform aperture predistortion, in accordance with some embodiments.

FIG. 7 is a flowchart illustrating operations for optimally selecting microphone elements of an array microphone using the array microphone of FIG. 6, in accordance with some embodiments.

FIGS. 8A-D are exemplary depictions of an algorithm for the optimal selection of microphone elements of an array microphone.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

The array microphone systems and methods described herein can enable predistortion of the aperture of an array microphone at various steering vectors to regularize the apparent aperture to be closer to that of the base aperture of the array microphone, while minimizing the number of microphone elements used.

In an embodiment, the array microphone may include a plurality of microphone elements, and one or more processors in communication with the microphone elements. In some embodiments, any of the one or more processors may generate and apply a mask to condition the signals of the microphone elements and generate filtered signals, based on the locations of the microphone elements and a steering vector for a lobe of the array microphone. The filtered signals may be utilized to generate a beamformed signal using any suitable beamforming technique, where the beamformed signal corresponds to the steered lobe of the array microphone with a regularized apparent aperture.

In another embodiment, any of the one or more processors may select bounding and interior microphone elements based on an apparent aperture of the array microphone. The apparent aperture may differ from the base aperture of the array microphone due to a steering vector for a lobe of the array microphone as well as due to a frequency range being sensed by the array microphone. The signals of the selected bounding and interior microphone elements may be utilized to generate a beamformed signal using any suitable beamforming technique, where the beamformed signal corresponds to the steered lobe of the array microphone with a regularized apparent aperture.

Through use of these embodiments, the apparent aperture of the array microphone can be modified and regularized at various steering vectors, resulting in improved directivity as well as more optimal pickup and capture of sound in the environment to, for example, avoid undesired noise and/or to more efficiently cover audio sources within an environment.

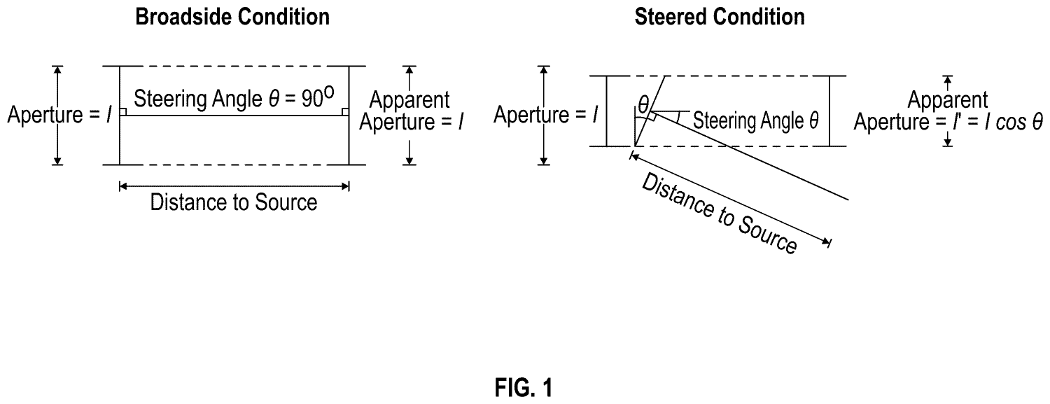

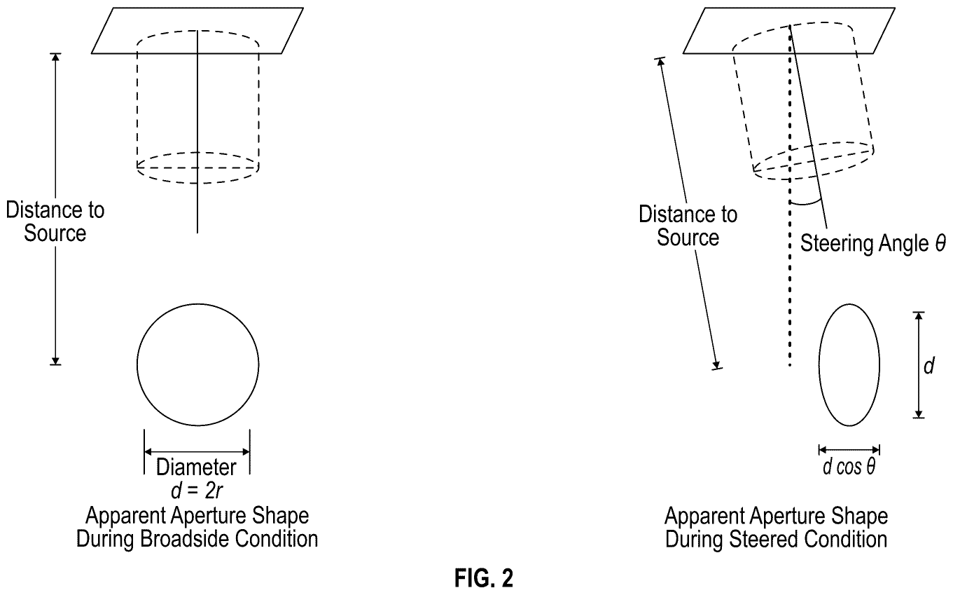

FIGS. 1 and 2 are depictions of array microphones being steered at ninety degrees (e.g., during a broadside condition) and at a steering angle θ (e.g., during a steered condition) towards sound sources in an environment, and showing the changes in the apparent apertures of the array microphones as compared to their base apertures.

In particular, FIG. 1 depicts a one-dimensional array microphone during a broadside condition and during a steered condition. During the broadside condition shown on the left side of FIG. 1, the widths l of the base aperture and the apparent aperture of the one-dimensional array microphone are equivalent. However, during the steered condition at a steering angle θ shown on the right side of FIG. 1, the width l′ of the apparent aperture of the one-dimensional array microphone is smaller than the width l of the base aperture, and the width l′ is equal to l cos θ. To counteract and compensate for the distorted apparent aperture during a steered condition, the base aperture of the one-dimensional array microphone can be pre-distorted by a factor of cos θ to scale the width of the base aperture to return to the width l.

FIG. 2 depicts a two-dimensional array microphone during a broadside condition and during a steered condition. During the broadside condition shown on the left side of FIG. 2, the shapes of the base aperture and the apparent aperture of the two-dimensional array microphone are equivalent, e.g., circular, which can be given as r²=x²+y² and have an eccentricity e of 0, where r is the radius of the circle with a corresponding diameter d. However, during the steered condition at a steering angle θ shown on the right side of FIG. 2, the shape of the apparent aperture of the two-dimensional array microphone is perturbed and becomes elliptical, which can be given as

$$\frac{{x}^{2}}{{r}^{2}} + \frac{{y}^{2}}{{( r cos θ )}^{2}} = 1 ,$$

and have an eccentricity

$$e = \sqrt{1 - \frac{{( r cos θ )}^{2}}{r}} .$$

The ellipse of the apparent as aperture during the steered condition may have a distance d between the vertices on the major axis, and a distance d cos θ between the co-vertices on the minor axis.

To counteract and compensate for the distorted apparent aperture during a steered condition, the base aperture of the two-dimensional array microphone can be pre-distorted by a factor of

$$\frac{1}{cos θ} = sec θ .$$

With such predistortion, the shape of the aperture can be given as

$$\frac{{x}^{2}}{{r}^{2}} + \frac{{y}^{2}}{{( r sec θ )}^{2}} = 1$$

with an eccentricity

$$e = \sqrt{1 - \frac{{( r sec θ )}^{2}}{r}} .$$

When the two-dimensional array microphone is in a steered condition at a steering angle θ, the shape of the aperture becomes

$$\frac{{x}^{2}}{{r}^{2}} + \frac{{y}^{2}}{{( r sec θ cos θ )}^{2}} = 1$$

which reduces to

$$\frac{{x}^{2}}{{r}^{2}} + \frac{{y}^{2}}{{r}^{2}} = 1 ,$$

and thus returns the shape of the aperture to r²=x²+y² with an eccentricity e of 0, i.e., the base aperture with a circular shape.

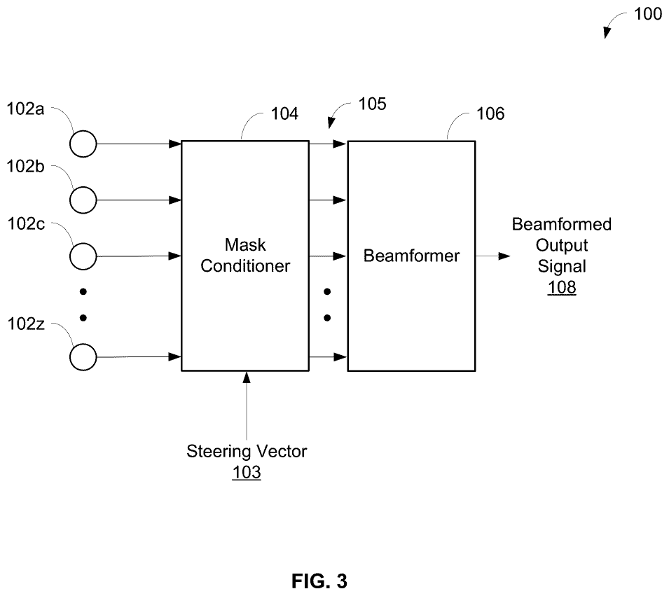

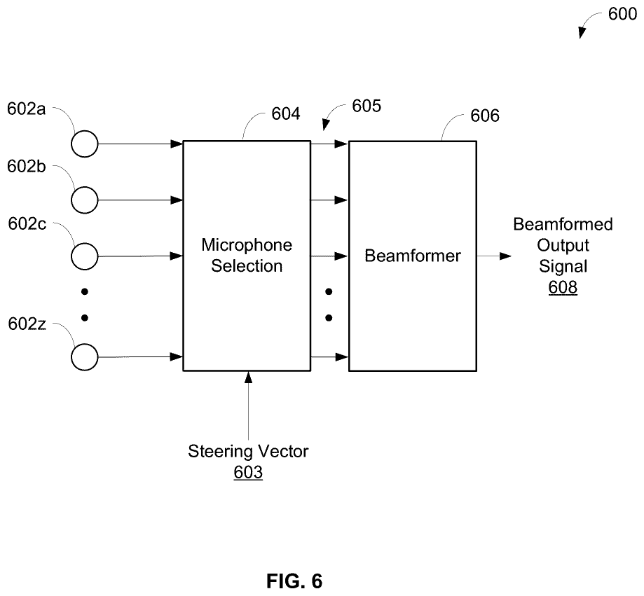

Accordingly, predistortion of the aperture of an array microphone of any geometry can be performed by the systems and methods described below by using mask conditioning and microphone element selection, in order to compensate for the distorted apparent apertures at various steering vectors. FIGS. 3 and 6 show block diagrams of respective array microphones 100, 600 that can perform predistortion of their apertures. The array microphones 100, 600 can detect sounds from one or more audio sources at various frequencies. The array microphones 100, 600 may be utilized in a conference room or boardroom, for example, where the audio sources may be one or more human speakers. Other sounds may be present in the environment which may be undesirable, such as noise from ventilation, other persons, audio/visual equipment, electronic devices, etc. In a typical situation, the audio sources may be seated in chairs at a table, although other configurations and placements of the audio sources are contemplated and possible.

The array microphones 100, 600 may be placed on a table, lectern, desktop, etc. so that the sound from the audio sources can be detected and captured, such as speech spoken by human speakers. The array microphones 100, 600 may include microphone elements 102a,b, . . . , zz, 602a,b, . . . , zz, for example, and be able to form multiple pickup patterns so that the sound from the audio sources can be detected and captured. Any appropriate number of microphone elements 102, 602 are possible and contemplated.

Each of the microphone elements 102, 602 in the array microphones 100, 600 may detect sound and convert the sound to an analog audio signal. Components in the array microphones 100, 600, such as analog to digital converters, processors, and/or other components, may process the analog audio signals and ultimately generate one or more digital audio output signals. The digital audio output signals may conform to the Dante standard for transmitting audio over Ethernet, in some embodiments, or may conform to another standard and/or transmission protocol. In embodiments, each of the microphone elements 102, 602 in the array microphones 100, 600 may detect sound and convert the sound to a digital audio signal. One or more pickup patterns may be formed by a beamformer 106, 606 in the array microphones 100, 600 from the audio signals of the microphone elements 102, 602, and the beamformer 106, 606 may generate a digital beamformed audio output signal 108, 608 corresponding to each of the pickup patterns. The beamformer 106, 606 may utilize any suitable beamforming algorithm in the time domain or frequency domain, such as delay and sum, filter and sum, differential, MVDR (Minimum Variance Distortionless Response), etc.

The pickup patterns may be composed of one or more lobes, e.g., main, side, and back lobes. In other embodiments, the microphone elements 102, 602 in the array microphones 100, 600 may output analog audio signals so that other components and devices (e.g., processors, mixers, recorders, amplifiers, etc.) external to the array microphones 100, 600 may process the analog audio signals. The various components included in the array microphones 100, 600 may be implemented using software executable by one or more servers or computers, such as a computing device with a processor and memory, and/or by hardware (e.g., discrete logic circuits, application specific integrated circuits (ASIC), programmable gate arrays (PGA), field programmable gate arrays (FPGA), etc.

The microphone elements 102, 602 of the array microphones 100, 600 may be arranged in any suitable regularized or non-regularized geometry. For example, the microphone elements 102, 602 may be arranged in concentric rings and/or be harmonically nested, in embodiments. In other embodiments, the microphone elements 102, 602 may be arranged to be generally symmetric, asymmetric, or in another arrangement. In further embodiments, the microphone elements 102, 602 may be arranged on a substrate, placed in a frame, or individually suspended, for example. An embodiment of an array microphone is described in commonly assigned U.S. Pat. No. 9,565,493, which is hereby incorporated by reference in its entirety herein. In embodiments, the microphone elements 102, 602 may be unidirectional microphones that are primarily sensitive in one direction. In other embodiments, the microphone elements 102, 602 may have other directionalities or polar patterns, such as cardioid, subcardioid, or omnidirectional, as desired. The microphone elements 102, 602 may be any suitable type of transducer that can detect the sound from an audio source and convert the sound to an electrical audio signal. In an embodiment, the microphone elements 102, 602 may be micro-electrical mechanical system (MEMS) microphones. In other embodiments, the microphone elements 102, 602 may be condenser microphones, balanced armature microphones, electret microphones, dynamic microphones, and/or other types of microphones. Particular microphone elements 102, 602 and/or groups of microphone elements 102, 602 may be positioned and configured to cover a specific frequency band within a range of operating frequencies, e.g., upper frequencies, lower frequencies, and/or other frequency bands.

Referring to FIG. 3, the array microphone 100 may perform mask conditioning to pre-distort its aperture by using a mask conditioner 104 that is in wired or wireless communication with the microphone elements 102. Based on a steering vector 103, the mask conditioner 104 may generate and apply a mask to filter the signals of the microphone elements 102 to pre-distort the aperture of the array microphone 100, and provide the filtered microphone signals 105 to the beamformer 106. The beamformer 106 may generate a beamformed output signal 108 that corresponds to the steered lobe of the array microphone 100 with a regularized apparent aperture, based on the filtered signals.

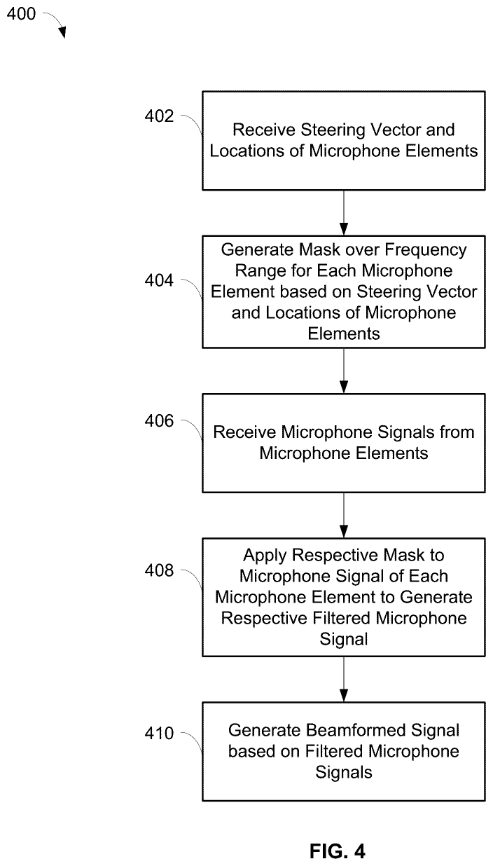

An embodiment of a process 400 for performing mask conditioning using the array microphone 100 is shown in FIG. 4. The process 400 may result in the beamformed output signal 108 that is generated based on a regularized apparent aperture for various steering vectors. One or more processors and/or other processing components (e.g., analog to digital converters, encryption chips, etc.) within or external to the microphone may perform any, some, or all of the steps of the process 400. One or more other types of components (e.g., memory, input and/or output devices, transmitters, receivers, buffers, drivers, discrete components, etc.) may also be utilized in conjunction with the processors and/or other processing components to perform any, some, or all of the steps of the process 400.

At step 402, a steering vector 103 and the locations of the microphone elements 102 may be received at the mask conditioner 104. The locations of the microphone elements 102 may be the distance of a particular microphone element 102 from the center of the array microphone 100. It should be noted that the center of the array microphone 100 may also be the center of the base aperture and the apparent aperture of the array microphone 100. In embodiments, the locations of the microphone elements 102 may be pre-stored in the mask conditioner 104. In some embodiments, the locations of the microphone elements 102 may be defined as the distances of the microphone elements 102 from another origin point.

The steering vector 103 may be determined programmatically or algorithmically using automated decision making schemes, in some embodiments, or may be manually input, e.g., by a user, in other embodiments. The steering vector may be determined or entered as a particular three dimensional coordinate relative to the location of the array microphone 100, such as in Cartesian coordinates (i.e., x, y, z), or in spherical coordinates (i.e., radial distance r, azimuthal angle θ (theta), polar or inclination angle q (phi)), for example.

In embodiments, the steering vector 103 may be determined by an audio activity localizer or other suitable component(s) that can determine the location of audio activity (e.g., desired sound sources) in an environment based on the audio signals from the microphone elements 102a, b, c, . . . , z. For example, the audio activity localizer may utilize a Steered-Response Power Phase Transform (SRP-PHAT) algorithm, a Generalized Cross Correlation Phase Transform (GCC-PHAT) algorithm, a time of arrival (TOA)-based algorithm, a time difference of arrival (TDOA)-based algorithm, or another suitable sound source localization algorithm. In embodiments, the audio activity localizer may be included in the array microphone 100, may be included in another component, or may be a standalone component.

At step 404, the mask conditioner 104 may generate a respective mask for each of the microphone elements 102, based on the location of a particular microphone element 102 and on the steering vector 103 as evaluated over a frequency range. In embodiments, each of the masks generated at step 404 may be a magnitude weight in the frequency domain and be the result of a continuous frequency domain function, such that each mask varies as a function of frequency for a particular location of a microphone element 102 and the steering vector 103. The mask generated at step 404 can represent the contribution of a particular microphone element 102 over the frequency range to the resulting beamformed output signal 108.

In embodiments, the mask conditioner 104 may generate a mask for a particular microphone element 102 according to a Gaussian distribution given by the equation:

$${e}^{- \frac{1}{2} [ \frac{{( \frac{x cos ( θ )}{sec ( φ )} )}^{2} + {( \frac{y sin ( θ )}{1} )}^{2}}{cfW} ]} \qquad ( 1 )$$

where (x, y) represents the location of a microphone element 102, θ represents an azimuth of the steering vector 103, φ represents an inclination of the steering vector 103, and cfW represents a constant dependent on the speed of sound c, a frequency f, and a beam width W. The beam width W may represent a desired width of a beam of the array microphone 100 that can vary depending on a particular environment.

Equation (1) can be derived from two equations: an equation representing an ellipse that is the shape of the apparent aperture of the array microphone 100 for a particular steering vector, and a Gaussian function that defines the magnitude weights for the aperture of the array microphone 100. The equation that represents the elliptical shape of the apparent aperture of the array microphone 100 can be given as:

$${( \frac{x cos θ}{sec φ} )}^{2} + {( \frac{y sin θ}{1} )}^{2} = r \qquad ( 2 )$$

where (x, y) represents the location of a microphone element 102, θ represents an azimuth of the steering vector 103, and φ represents an inclination of the steering vector 103. Equation (2) may be derived through a rotational transform in the plane of the base aperture relative to the azimuth θ of the steering vector 103 and pre-distorted with respect to the inclination φ of the steering vector 103.

The Gaussian function that defines the magnitude weights for the aperture of the array microphone 100 can be given as:

$${e}^{- {\frac{1}{2} [ \frac{r}{cfW} ]}^{2}} . \qquad ( 3 )$$

Equation (3) may be defined so that the sidelobes are minimized for a particular pickup pattern of the array microphone 100 at the expense of beam width W. Equation (1) above can then be derived by substituting equation (2) into equation (3).

At step 406, the mask conditioner 104 may receive the audio signals from the microphone elements 102. At step 408, the respective masks generated at step 404 may be applied to each of the signals from the microphone elements 102 to generate respective filtered microphone signals 105. The filtered microphone signals 105 may compensate for the eccentricity of the apparent aperture of the array microphone 100 when in a steered condition at steering vector 103. The beamformed output signal 108 may be generated at step 410 by the beamformer 106, based on the filtered microphone signals 105 generated at step 408. The beamformed output signal 108 may correspond to a pickup pattern that is steered according to the steering vector 103.

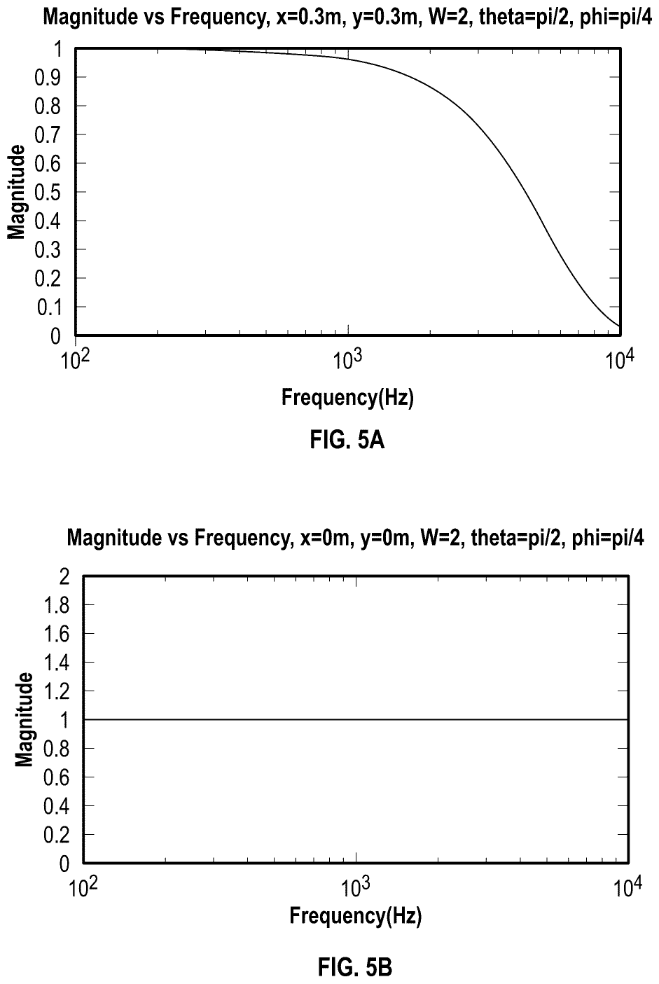

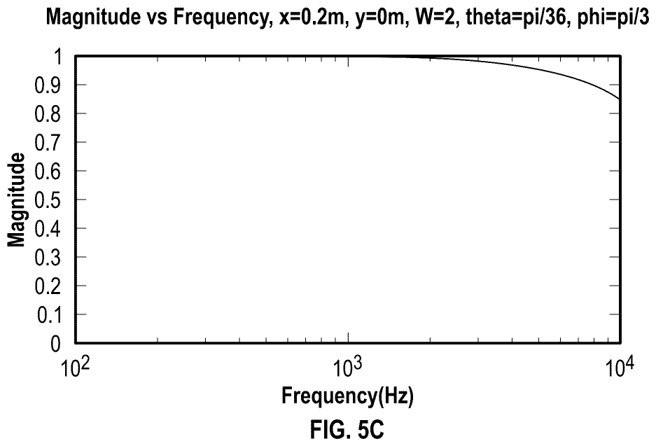

FIGS. 5A-C shows exemplary graphs depicting the magnitudes of the mask that can be applied to the audio signals of the microphone elements 102 of an array microphone 100, as described above. The graphs show the magnitudes of the mask (on the y-axis) versus frequency (on the x-axis) for different beam widths and for different locations of microphone elements 102 and steering vectors 103.

In general, the further a microphone element 102 is from the center of the array microphone 100 (as well as the centers of the aperture and the apparent aperture), the less high frequency content is contributed to the beamformed output signal 108. Given a particular location of a microphone element 102, as the azimuth tends toward the location, more high frequency content will be contributed to the beamformed output signal 108. Moreover, given a particular location of a microphone elements 102 along the azimuthal vector, as the inclination increases, the high frequency content contribution to the beamformed output signal 108 will also increase. For all of these increases in the high frequency content, the magnitude of the mask that has a maximum contribution is a value of 1.

For example, the graph of FIG. 5A shows the magnitudes of a mask for a microphone element 102 positioned at a location defined by x=0.3 m and y=0.3 m with a beam width scaling factor of 2, and where the steering vector 103 has an azimuth of

$$\frac{π}{2}$$

radians and an inclination of

$$\frac{π}{4}$$

radians. The graph of FIG. 5B shows the magnitudes of a mask for a microphone element 102 positioned at a location defined by x=0 m and y=0 m (e.g., at the center of the array microphone 100) with a beam width scaling factor of 2, and where the steering vector 103 has an azimuth of

$$\frac{π}{2}$$

radians and an inclination of

$$\frac{π}{4}$$

radians. The graph of FIG. 5C shows the magnitudes of a mask for a microphone element 102 positioned at a location defined by x=0.2 m and y=0 m with a beam width scaling factor of 2, and where the steering vector 103 has an azimuth

$$\frac{π}{36}$$

radians and an inclination of

$$\frac{π}{3}$$

radians.

In the graph of FIG. 5C, it can be seen that more high frequency content may be included in the beamformed output signal 108 since the magnitudes of the mask are higher across the frequency range. This may be due to the location of the microphone element 102 for the graph of FIG. 5C being closer to the center of the array microphone 100. In contrast, the graph of FIG. 5A shows that less high frequency content may be included in the beamformed output signal 108, since the location of the microphone element 102 for the graph of FIG. 5A is further from the center of the array microphone 100. The graph of FIG. 5B shows that the magnitude of the mask is 1 and constant across the frequency range for a microphone element 102 at the center of the array microphone 100.

Referring now to FIG. 6, the array microphone 600 may select particular microphone elements 602 to pre-distort its aperture by using a microphone selection module 604 that is in wired or wireless communication with the microphone elements 602. Based on a steering vector 603, the microphone selection module 604 may utilize an algorithm to select an optimal set of microphone elements 602, based on an apparent aperture of the array microphone 600. The apparent aperture of the array microphone 600 may vary depending on the steering vector 603. The signals of the selected microphone elements 602 may be used by a beamformer 606 to generate a beamformed output signal 608 that corresponds to the steered lobe of the array microphone 600 with a regularized apparent aperture.

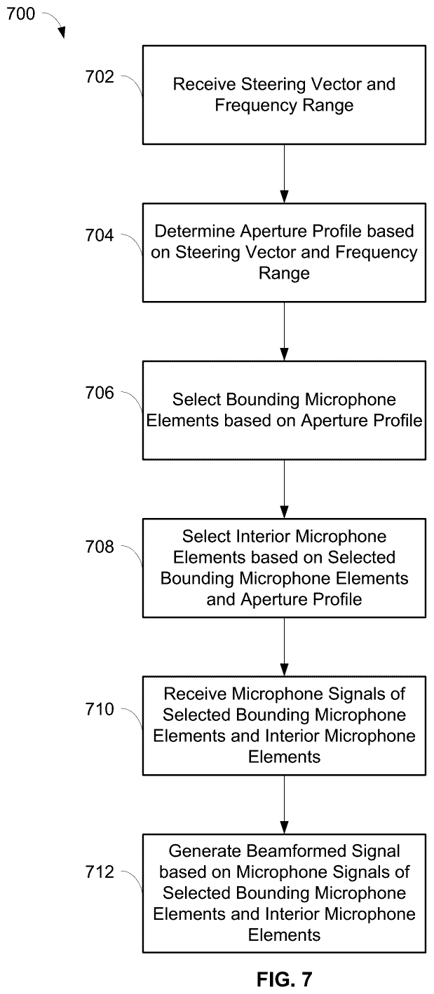

An embodiment of a process 700 for selecting microphone elements 602 of the array microphone 600 is shown in FIG. 7. The process 700 may result in the beamformed output signal 108 that is based on a regularized apparent aperture for various steering vectors. One or more processors and/or other processing components (e.g., analog to digital converters, encryption chips, etc.) within or external to the microphone may perform any, some, or all of the steps of the process 700. One or more other types of components (e.g., memory, input and/or output devices, transmitters, receivers, buffers, drivers, discrete components, etc.) may also be utilized in conjunction with the processors and/or other processing components to perform any, some, or all of the steps of the process 700.

At step 702, a steering vector 603 and a frequency range being sensed by the array microphone 600 may be received at the microphone selection module 604. The frequency range being sensed by the array microphone 600 may correspond to a particular subnest of microphone elements 602 that is configured to sense that particular frequency range. For example, the microphone elements 602 in each subnest may be band selected for the frequency band that the aperture is most well-conditioned by using a bandpass filter.

The steering vector 603 may be determined programmatically or algorithmically using automated decision making schemes, in some embodiments, or may be manually input, e.g., by a user, in other embodiments. The steering vector may be determined or entered as a particular three dimensional coordinate relative to the location of the array microphone 600, such as in Cartesian coordinates (i.e., x, y, z), or in spherical coordinates (i.e., radial distance r, azimuthal angle θ (theta), polar or inclination angle q (phi)), for example.

In embodiments, the steering vector 603 may be determined by an audio activity localizer or other suitable component(s) that can determine the location of audio activity (e.g., desired sound sources) in an environment based on the audio signals from the microphone elements 602a, b, c, . . . , z. For example, the audio activity localizer may utilize a Steered-Response Power Phase Transform (SRP-PHAT) algorithm, a Generalized Cross Correlation Phase Transform (GCC-PHAT) algorithm, a time of arrival (TOA)-based algorithm, a time difference of arrival (TDOA)-based algorithm, or another suitable sound source localization algorithm. In embodiments, the audio activity localizer may be included in the array microphone 600, may be included in another component, or may be a standalone component.

At step 704, an aperture profile corresponding to a pre-distorted aperture may be determined by the microphone selection module 604, based on the steering vector 603 and the frequency range received at step 702. The pre-distorted aperture may be the aperture that allows the apparent aperture to match the ideal aperture, e.g., a circular aperture. The aperture profile may be determined at step 704 for a particular subnest of microphone elements 602 that is configured to sense the particular frequency range received at step 702. In embodiments, aperture profiles may have been generated and pre-stored for the subnests of microphone elements 602 of the array microphone 600 so that the appropriate aperture profile can be selected and determined at step 704.

At step 706, the microphone selection module 604 may select bounding microphone elements of the microphone elements 602, based on the aperture profile determined at step 704. In embodiments, a number of evenly distributed microphone elements 602 that are nearest to the boundaries of the aperture profile may be selected as the bounding microphone elements at step 706. The aspect ratio of the aperture profile may also be utilized when selecting the bounding microphone elements at step 706.

After the bounding microphone elements are selected at step 706, the microphone selection module 604, at step 708, may select interior microphone elements of the microphone elements 602, based on the aperture profile and the bounding microphone elements. In embodiments, a uniform distribution of microphone elements 602 that are within the bounding microphone elements and that have a similar aspect ratio as the aperture profile may be selected as the interior microphone elements at step 708. In general, the bounding microphone elements and the interior microphone elements selected at steps 706 and 708 may be the microphone elements 602 that most closely fit the aperture profile determined at step 704. Moreover, the selected bounding microphone elements and the interior microphone elements may compensate for the eccentricity of the apparent aperture of the array microphone 600 when in a steered condition at steering vector 603.

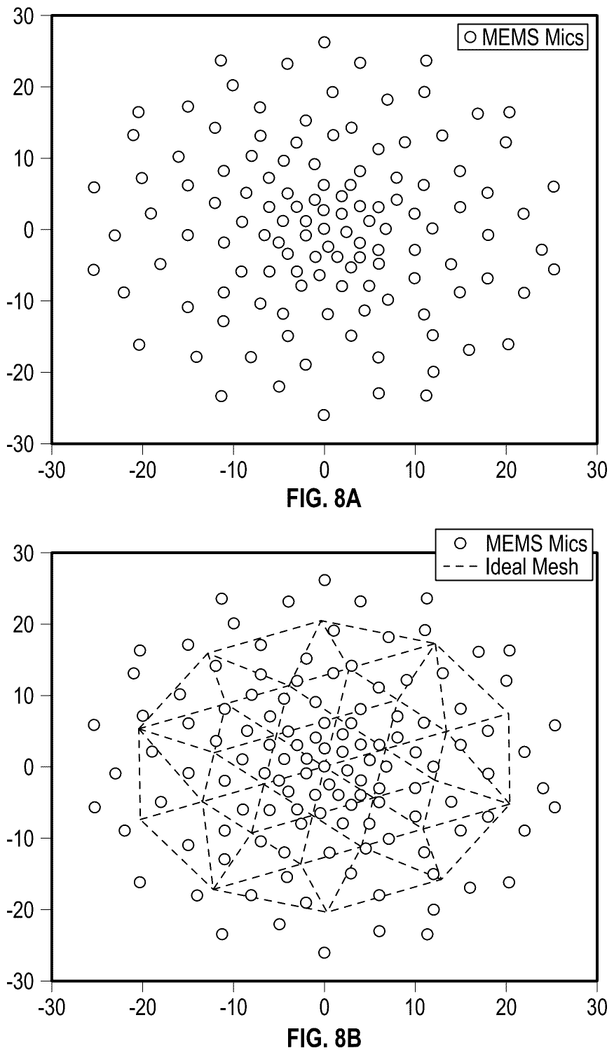

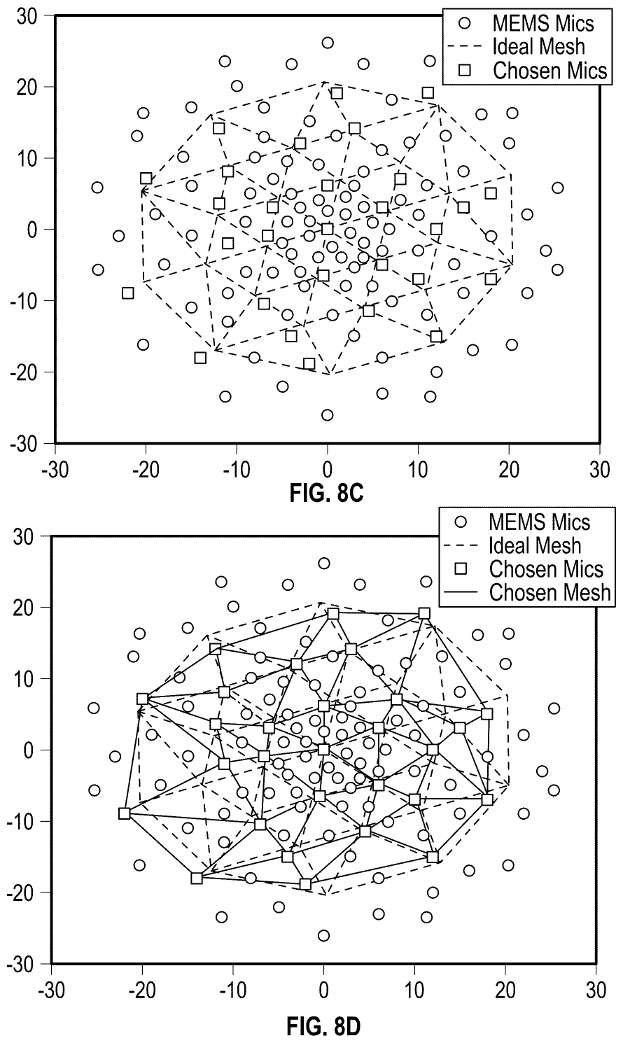

Exemplary depictions of the selection of microphone elements 602 of the array microphone 600 using the process 700 are shown in FIGS. 8A-D. The depictions in FIGS. 8A-D show exemplary selected microphone elements that result from the microphone selection process 700 for a steering vector having a 20° elevation and a 20° azimuth.

FIG. 8A depicts an exemplary configuration of microphone elements and their physical locations in an array microphone (shown as empty circles and labeled “mems mics”). The locations of the microphone elements are shown in FIGS. 8A-D with coordinates measured in centimeters from the center of the array microphone. FIG. 8B depicts a particular aperture profile that corresponds to a particular steering vector of the array microphone (shown as dashed lines and labeled “ideal mesh”), e.g., steps 702 and 704 of the process 700.

FIG. 8C depicts the bounding microphone elements and interior microphone elements that may be selected to be closest to the aperture profile (shown as solid circles and labeled “chosen mics”), e.g., steps 706 and 708 of the process 700. FIG. 8D depicts the apparent aperture that is formed from the selected bounding microphone elements and interior microphone elements (shown as solid lines and labeled “chosen mesh”). As can be seen, the selected bounding microphone elements and interior microphone elements are selected so that the apparent aperture has a similar shape as the aperture profile for a particular steering vector. In general, the minor axis of the ellipse that is generated for the apparent aperture may be the same as that of the base circular aperture, and the major axis of the ellipse of the apparent aperture may be scaled by the inclination φ of the steering vector (e.g., by seco), and may be aligned with the azimuth θ of the steering vector.

Returning to FIG. 7, at step 710, the beamformer 606 may receive the audio signals 605 of the selected bounding microphone elements and interior microphone elements from the microphone selection module 604. Using the signals from the selected bounding microphone elements and interior microphone elements may compensate for the eccentricity of the apparent aperture of the array microphone 600 when in a steered condition at steering vector 603.

The beamformed output signal 608 may be generated at step 712 by the beamformer 606, based on the signals from the selected bounding microphone elements and interior microphone elements received at step 710. The beamformed output signal 608 may correspond to a pickup pattern that is steered according to the steering vector 603. In embodiments, steps 702-710 may be repeated for each subnest of microphone elements 602, and at step 712, the signals of the respective selected bounding microphone elements and interior microphone elements of each subnest may be summed together to generate the beamformed output signal 608 having a full bandwidth response.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A device, comprising:
an array microphone comprising a plurality of microphone elements; and
one or more processors in communication with the plurality of microphone elements, the one or more processors configured to:
generate a respective mask for each of the plurality of microphone elements based on: a location of each of the plurality of microphone elements and a steering vector;
receive a microphone signal from each of the plurality of microphone elements;
apply the respective mask to the microphone signal of each of the plurality of microphone elements to generate a respective filtered microphone signal; and
generate a beamformed signal based on the filtered microphone signals.

2. The device of claim 1, wherein the respective mask comprises a magnitude weight in the frequency domain, and any of the one or more processors is configured to apply the respective mask by multiplying the respective magnitude weight with the microphone signal of each of the plurality of microphone elements to generate the respective filtered microphone signal.

3. The device of claim 1, wherein any of the one or more processors is configured to generate the respective mask in the frequency domain, and based on: the location of each of the plurality of microphone elements and the steering vector.

4. The device of claim 3, wherein any of the one or more processors is configured to generate the respective mask in the frequency domain according to a Gaussian distribution that includes a frequency range, the location of each of the plurality of microphone elements, and the steering vector.

5. The device of claim 1, wherein any of the one or more processors is configured to generate the respective mask for each of the plurality of microphone elements based on: the location of each of the plurality of microphone elements, the steering vector, and a frequency range being sensed by the array microphone.

6. The device of claim 1, wherein the location of each of the plurality of microphone elements comprises a distance of one of the plurality of microphone elements from a center of the array microphone.

7. The device of claim 6, wherein the respective mask comprises a magnitude weight in the frequency domain that is a function of the distance of the one of the plurality of microphone elements from the center of the array microphone.

8. The device of claim 1, wherein the respective mask generated for each of the plurality of microphone elements is configured to compensate for an eccentricity of an apparent aperture of the array microphone.

9. The device of claim 1, wherein an apparent aperture of the array microphone is dependent on the steering vector, and wherein the respective mask generated for each of the plurality of microphone elements is configured to regularize the apparent aperture.

10. The device of claim 1, wherein the steering vector comprises an azimuth and an inclination, and wherein the respective mask comprises a magnitude weight in the frequency domain that is a function of one or more of the azimuth or the inclination of the steering vector.

11. A device, comprising:
an array microphone comprising a plurality of microphone elements; and
one or more processors in communication with the plurality of microphone elements, the one or more processors configured to:
determine an aperture profile based on a steering vector and a frequency range being sensed by the array microphone;
select one or more bounding microphone elements of the plurality of microphone elements based on the aperture profile;
select one or more interior microphone elements of the plurality of microphone elements based on the one or more bounding microphone elements and the aperture profile;
receive microphone signals of the selected one or more bounding microphone elements and the selected one or more interior microphone elements; and
generate a beamformed signal based on the microphone signals of the selected one or more bounding microphone elements and the selected one or more interior microphone elements.

12. The device of claim 11, wherein the selected one or more bounding microphone elements and the selected one or more interior microphone elements comprise one or more of a subnest of the plurality of microphone elements that are configured to sense the frequency range.

13. The device of claim 11, wherein any of the one or more processors is configured to select the one or more bounding microphone elements by selecting one or more of the plurality of microphone elements based on a boundary of the aperture profile.

14. The device of claim 11, wherein any of the one or more processors is configured to select the one or more interior microphone elements by selecting one or more of the plurality of microphone elements located within the one or more bounding microphone elements.

15. The device of claim 11, wherein any of the one or more processors is configured to select the one or more interior microphone elements by selecting a uniform distribution of one or more of the plurality of microphone elements located within the one or more bounding microphone elements.

16. The device of claim 11, wherein any of the one or more processors is configured to select the one or more bounding microphone elements by selecting one or more of the plurality of microphone elements based on an aspect ratio of the aperture profile.

17. The device of claim 11, wherein any of the one or more processors is configured to select the one or more interior microphone elements by selecting one or more of the plurality of microphone elements based on an aspect ratio of the aperture profile.

18. The device of claim 11, wherein the selection of the one or more bounding microphone elements and the selection of the one or more interior microphone elements is configured to compensate for an eccentricity of an apparent aperture of the array microphone.

19. The device of claim 11, wherein the aperture profile corresponds to a pre-distorted aperture that is configured to allow an apparent aperture of the array microphone to match an ideal aperture of the array microphone.

20. The device of claim 11, wherein an apparent aperture of the array microphone is dependent on the steering vector, and wherein the selected one or more bounding microphone elements and the selected one or more interior microphone elements are selected to regularize the apparent aperture.
